(19) United States
(12) Patent Application Publication
(10) Pub. No.: US 2017/0187884 A1
(43) Pub. Date: Jun. 29, 2017

(54) Controlling output volume levels

(71) Applicant: Microsoft Technology Licensing, LLC, Redmond, WA (US)

(72) Inventor: Owen Minor, Woodinville, WA (US)

(21) Appl. No.: 14/998,173

(22) Filed: Dec. 23, 2015

(51) Int. Cl. H04M 3/56; H04L 29/06; H04M 7/00

(52) U.S. Cl. CPC H04M 3/568; H04M 7/006; H04L 65/403

(57) ABSTRACT

A method of operating a first user terminal of a first user, comprising: running a first communication client application on the first user terminal so as to enable the first user terminal to participate in a group communication session over a network with respective communication clients running on other user terminals; receiving, by the first user terminal, a plurality of audio data streams, each carrying audio data generated at a respective one of the other user terminals; the first communication client associating each of the received audio data streams with a respective user of one said other user terminals; the first communication client outputting the received audio data streams through one or more audio output devices associated with the first user terminal; and independently controlling, within an audible range, an output volume level of at least a selected one of the received audio data streams output through the one or more audio output devices.

### BACKGROUND

Packet-based communication networks such as the Internet have developed to allow highly efficient transmission of large quantities of communication traffic between users of different user terminals. Communication data can be exchanged over the packet-based network between the user terminals of two or more users. As an example, the two or more user terminals may exchange audio communications in a Voice over Internet Protocol (VoIP) session.

To participate in the VoIP session each user runs a communication client application on his or her respective terminal. When the user runs the communication client, the client allows the user to make or accept contact requests to or from other users of the communication system and thereby become pre-agreed contacts, and to then establish a communication connection with one or more of those contacts so as to send and receive communications over the network. In a group session (or group call) multiple users may use their respective user terminals to capture audio input and transmit the captured audio as audio data streams over the network to be received by all of the other user terminals. The transmitted audio streams may be mixed and processed either by the respective receiving clients, remote server (or both) so that each user terminal participating in the group session can output the audio data received from each of the other user terminals being used in the session. Such VoIP group sessions may be known as conference calls. Video data may also be transmitted between the user terminals so that audio-visual communications can be output at the user terminals.

The communication data is typically exchanged in real-time so that communications sessions are conducted live, although some systems may also provide a server which can store messages for later delivery if one of the contacts involved intended to be part of a particular communication session is offline at the time the session is held.

The communication clients may support additional types of communication such as file transfer and/or text based communications such as instant messaging (IM) “chat”.

In some communication systems, during a call a graphical user interface of a first user's communication client may display a graphic that indicates when each of the one or more other users participating in the call is speaking. Other graphics may be displayed proximate to a visual representation of each of the contacts participating in the call. For example a graphic may show the first user when another contact has set a mute control in their communication client, intentionally blocking audio from being received by the contacts participating in the call.

### SUMMARY

Group communication sessions such as those described above generally fail to simulate the benefits that are associated with real world discussions held between teams of people located in an open plan environment. For example, it may be beneficial that members in a team are able to overhear discussions held between one another in the open plan environment as this can aid collaboration between the team members. However, in this scenario spoken audio is not direct and therefore not as loud as a one-to-one direct communication. Using private offices or telecommunication methods may improve the audibility for the team members but this breaks down the collaborative nature of the open plan environment.

The present disclosure provides a more flexible communication system that can be configured from the perspective of a first user so that an open plan environment can be simulated between users but managed so that the first users can control audio volume level output of one or more other users but without necessarily breaking the simulated open-plan environment.

According to one aspect of the present disclosure, there is provided a method of operating a first user terminal of a first user, comprising: running a first communication client application on the first user terminal so as to enable the first user terminal to participate in a group communication session over a network with respective communication clients running on other user terminals; receiving, by the first user terminal, a plurality of audio data streams, each carrying audio data that has been generated at a respective one of the other user terminals; the first communication client associating each of the received audio data streams with a respective user of one said other user terminals; the first communication client outputting the received audio data streams through one or more audio output devices associated with the first user terminal; and independently controlling, within an audible range, an output volume level of at least a selected one of the received audio data streams output through the one or more audio output devices.

According to another aspect of the present disclosure, there is provided a first user terminal of a first user, comprising: a processor configured to run a first communication client application on the first user terminal so as to enable the first user terminal to participate in a group communication session over a network with respective communication clients running on other user terminals; a network interface configured for receiving plurality of audio data streams, each carrying audio data that has been generated at a respective one of the other user terminals; wherein the first communication client is configured for: associating each of the received audio data streams with a respective user of one said other user terminals; outputting the received audio data streams through one or more audio output devices associated with the first user terminal; and independently controlling, within an audible range, an output volume level of at least a selected one of the received audio data streams output through the one or more audio output devices.

According to another aspect of the present disclosure, there is provided a communication client application embodied on a computer-readable storage medium and comprising code configured so as when ran on a first user terminal to perform the above described method.

This summary is provided to introduce a selection of concepts in a simplified form that are further described below in the Detailed Description. This summary is not intended to identify key features of essential features of the claimed subject matter, nor is it intended to be used to limit the scope of the claimed subject matter.

### BRIEF DESCRIPTION OF THE DRAWINGS

For a better understanding of the present disclosure and to show how it may be put into effect, reference is made by way of example to the accompanying drawings in which:

FIG. 1 is a schematic representation of a communication network.

FIG. 1a is a schematic representation of one exemplary configuration of a communication network.

FIG. 2 is a schematic block diagram of a user terminal.

FIG. 3 is schematic representation of a meeting room interface according to the present disclosure.

FIG. 3a is schematic representation of a control window interface according to the present disclosure.

FIG. 3b a schematic representation of a volume control mixer interface.

FIG. 4 is another schematic representation of the meeting room interface according to the present disclosure.

FIG. 4a is another schematic representation of the meeting room interface according to the present disclosure.

FIG. 4b is another schematic representation of the meeting room interface according to the present disclosure.

FIG. 5 is another schematic representation of the meeting room interface according to the present disclosure.

### DETAILED DESCRIPTION OF PREFERRED EMBODIMENTS

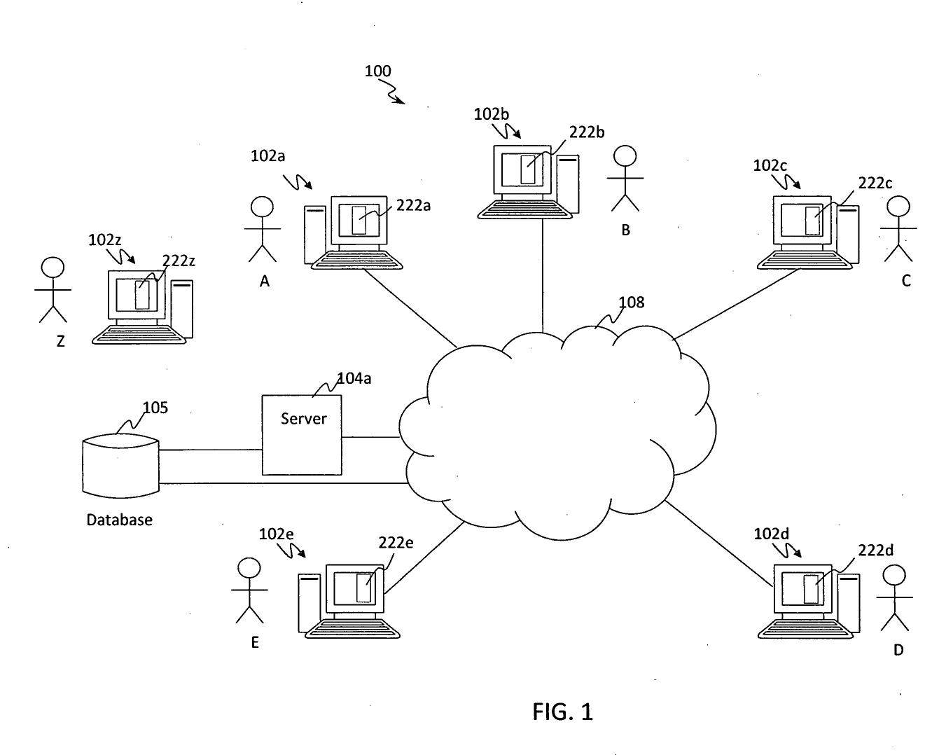

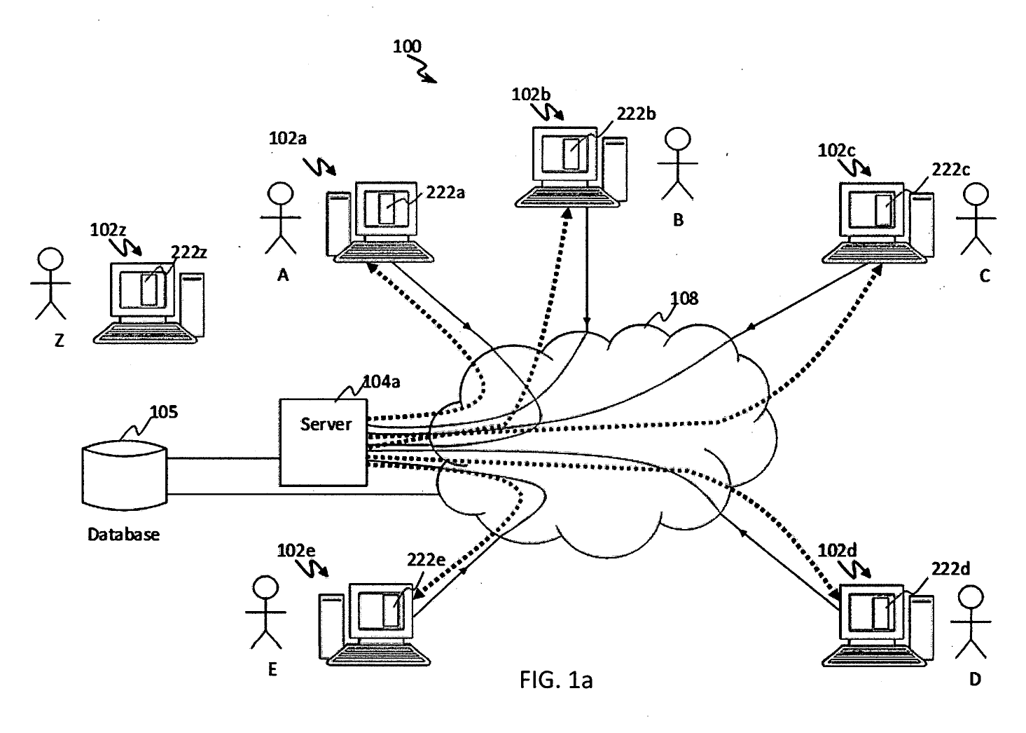

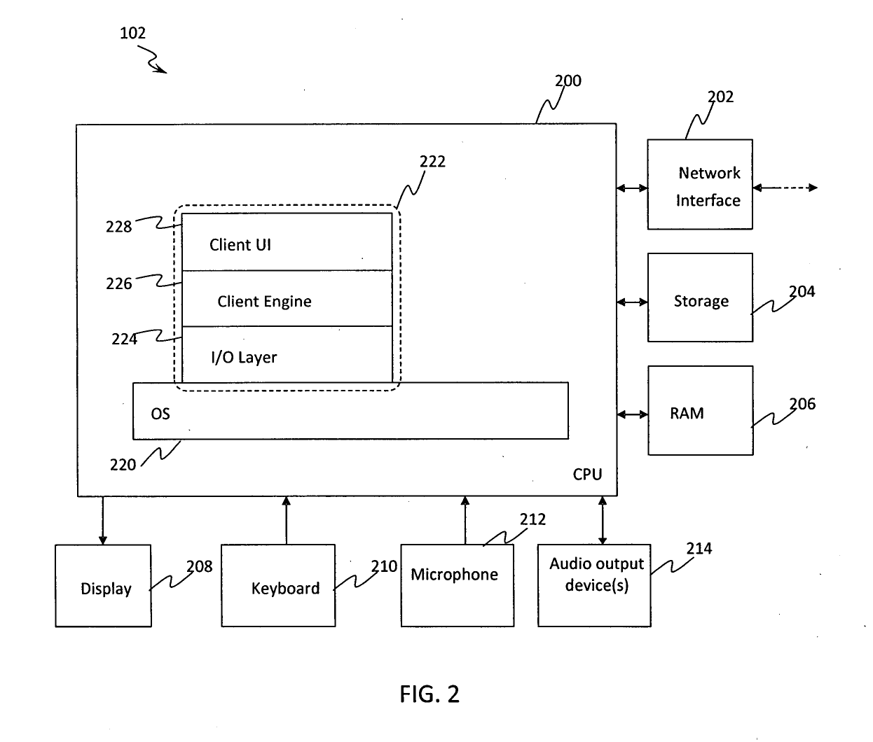

FIGS. 1, 1a and 2 schematically illustrate a communication system 100, in this case a communication system implemented over a packet-switched network such as the Internet. A plurality of end-user terminals 102 and servers 104 are each connected to the Internet, represented schematically as a communication “cloud” 108 comprising a plurality of inter-networked routing nodes for routing packets of data between the user terminals 102 and/or servers 104. Each of the connections between a user terminal 102 and the cloud 108 may comprise a link via a wired or wireless modem, and may or may not be made via another network such as a local area network or packet-based service of a cellular network operator, etc. Although network 108 is referred to as being a packet-switched network, it may instead be implemented as a circuit-switched network. Details of the various possible arrangements for accessing the Internet will be familiar to a person skilled in the art. Each of the user terminals are shown associated with a user A, B, C, D, E. It will be appreciated there may be more or fewer user terminals than those shown by FIG. 1. The user terminals 102 may be any one of (but not limited to): Personal Computers (PC), laptops, mobile telephones (smartphones), gaming consoles, Personal Digital Assistants (PDA), tablet computers, wearable technology devices e.g. smartwatches, virtual reality headsets, etc.

In order to implement the communication system for transmitting and receiving encoded audio data (e.g. VoIP data) between contacts, each of a plurality of user terminals 102 is installed with a respective instance of a communication client application 222, as shown in FIG. 2. The communication client 222 also provides a number of additional communication types over the Internet, such as video, instant messaging and/or file transfers.

As shown in FIG. 2, the user terminal 102 comprises a processing apparatus 200 in the form of one or more central processing units (CPUs). The processing apparatus 200 is operatively coupled to a plurality of devices: a network interface 202 for connecting to the Internet 108, a non-volatile storage medium 204 such as an internal or external hard drive and/or flash memory, a volatile storage medium in the form of a RAM 206, a display 208 such as an LED or LCD screen, a user input device 210 such as a keyboard, a microphone 212, one or more audio speaker(s) 214, and one or more other input and/or output devices (not shown) such as a mouse and/or touch screen system capable of receiving user input controls. The terminal 102 is installed with the instance of the communication client 202, in that the client 222 is stored in the non-volatile storage medium 204 and arranged to be run on the processing apparatus 200 (typically under control of an operating system 220 also running on the processing apparatus 200). The client application 222 comprises an I/O layer 224, a client engine layer 226 and a client user interface (UI) layer 228.

In operation, the I/O layer 224 handles the lower-level codecs for encoding and decoding text, voice and/or video communications for the purpose of transmission and reception over the Internet. The client engine 226 is then responsible for managing a list of contacts and for establishing communication channels with the instance of the client application 222 running on the other user terminals 102 of selected contacts. The UI layer 228 is responsible for outputting an on-screen user interface to the user via the display 208, including on-screen controls for managing communications and for displaying IM chat messages.

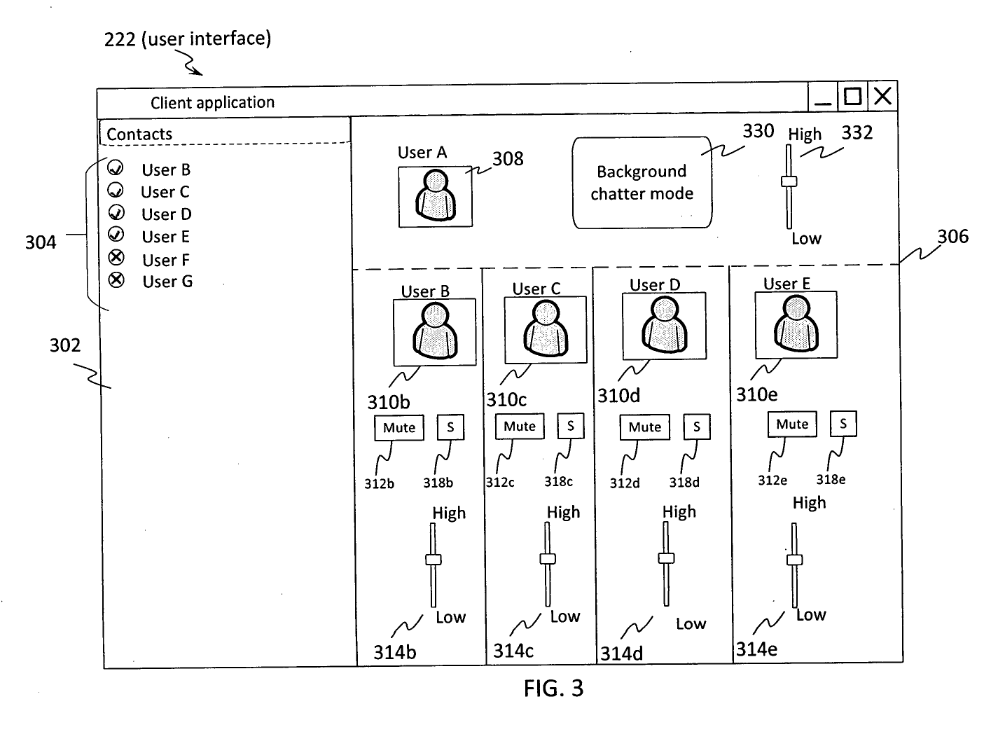

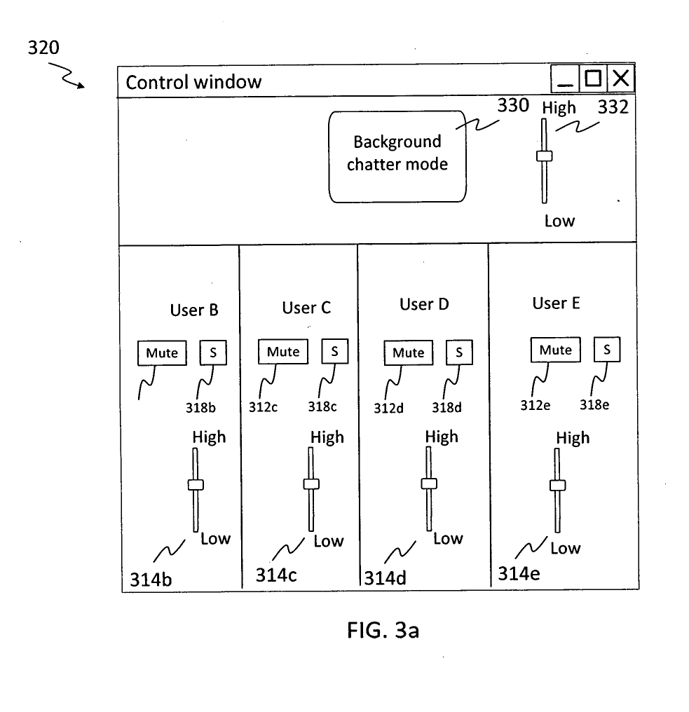

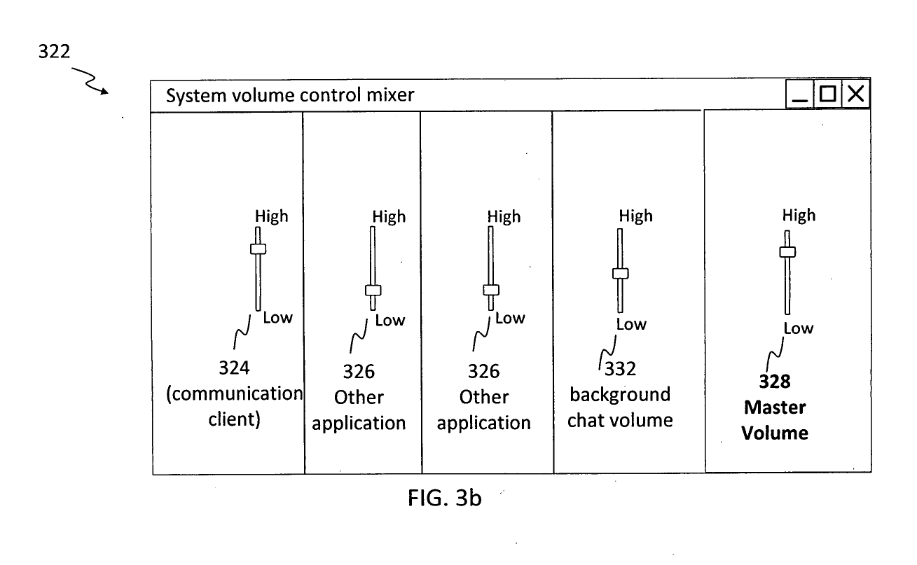

FIG. 3 shows a schematic illustration of an example user interface of a first client application 222 as displayed to a first user, implemented by the UI layer 228. The user interface may comprise a number of windows, panels or panes (the terms are not intended herein to be overly limiting and can be used interchangeably to refer to any portion of a user interface). In a first pane 302 is a list of contacts of the first user. Each contact may be graphically represented 304 and one or more the contacts can be selected by the first user to establish a communication session between the first user and the selected contacts. For simplicity the contacts are shown as Users A to G, however it will be appreciated that the users may be displayed in the various graphical user interfaces of the communication client 222 with text of one or more of their actual name or nickname, their username, or a contact address (e.g. an email address). Pane 306 is a “meeting room interface” area established once an audio communication session has been established between the first user and a number of other contacts. The first user may initiate the call, or the first user may accept a call that is initiated by one of the other users and that he is invited to take part in. It may be possible for any of the users on the call to invite one or more other contacts to join in the call once it has started.

Within the meeting room interface 306 the first user is graphically represented in area 308. The other contacts taking part in the call are shown graphically represented in areas 310 in the call meeting room interface 306. The graphic representations in areas 308 and 310 may be resized according to the first user's preference. Each of the graphical representations in areas 308 and 310 are static images during an audio only call. The areas 308 and 310 may be populated with a video if the respective user terminal 102 has access to a webcam input. In the present disclosure reference is made primarily to audio only calls.

In the example user interface shown in FIG. 3, an audio call has been established between five users, namely the first user (user A) represented in area 308, and users B, C, D and E each respectively represented in areas 310. It will be appreciated the audio call may involve more or fewer users than those shown in FIG. 3.

In a first embodiment, a number of audio controls are visually displayed in the meeting room interface during an established audio call. The audio controls include a series of “mute” control buttons 312, a series of “audio volume level” control sliders 314, and a series of “solo” control buttons 318, wherein each series of controls is associated with a respective one of the users B, C, D and E participating in the audio call. The audio controls further comprise a background chatter mode control 330 and background chatter mode volume level slider 332.

Each of these audio controls are explained in detail below. One or more of the audio controls 312, 314, 318, 330 and 332 may be hidden from view in the meeting room interface 306. As shown by FIG. 3a, the audio controls 312, 314, 318, 330 and 332 may be accessible in a separate control window 320 alternatively or in addition to being accessible directly in the meeting room interface 306. It will be understood that the audio controls shown in the example Figures are examples of how the controls may be visually represented in the user interface of the communication client 222. Other alternative configurations will be apparent to the skilled person.

During the audio call a series of audio channels are established between the user terminals 102 so that audio input data at each of the communication clients 222 can be encoded and transmitted over the network 108 to each of the other communication clients 222 in the call. When audio data is received from the network 108 by a communication client 222, the data has typically been combined into a single data stream either at a centralized server or by one or more communication clients 102 in a distributed fashion (e.g. peer to peer). However, in the present disclosure, for the purpose of the group audio call, the input and output audio channels established by each communication client 222 are not combined but left independently exposed.

The audio data channels may be routed by the communication clients 222 via a server 104a which is configured to forward the appropriate data streams on to the other communication client 222. In embodiments the first user terminal 102a transmits an encoded stream of audio data to the server 104a but with additional side information in the form of a volume instruction for the volume level the audio data should be played out at when it is decoded by each of the receiving user terminals (explained in more detail later). For example, the audio data originating from a first communication client 222a of a first user (user A) will be routed by the server 104a to the communication clients of the other users B, C, D and E as shown in FIG. 1. Similarly audio data originating from communication client 222b of the user B will be routed by the server 104a to the communication clients of the other users A, C, D and E, and so on. The audio data originating from a first user terminal 102 may include audio input received from the microphone 212 and/or audio generated by the user terminal 102a for the purpose of the group call; e.g. the playing back of shared audio media such as a sound clip or an audio presentation.

The server 104a may be configured to implement one or more known audio codecs that can handle ‘n’ incoming audio channel streams transmitted by the user terminals 102 in the group call. The server 104a may be used to bridge the audio and/or video channel connections between the users' use terminals 102. Such a server is sometimes known as audio-visual multipoint control unit (AV MCU). An example of a well-known AV MCU that may be suitable for use in the present disclosure is the Microsoft® Skype for Business Server. In an alternative embodiment, the routing of the exposed streams may be handled in a distributed fashion by the communication clients 222 themselves e.g. peer-to-peer.

For example, as illustrated in FIG. 1a, the communication clients 222 can send their audio stream to the central server 104a, e.g. AV MCU. The central server 104a is then configured to relay the multiple audio streams to the communication clients 222a-e in a multi-channel audio stream. For the purposes of illustration, the multi-channel streams are shown in FIG. 1a with thick dotted lines, while the single channel audio streams are shown with plain arrows. Each communication client 222a-e receives a copy of the stream and is able to mix audio at the client side.

The exposed audio channels that are received over the network 108 by the first communication client 222a are respectively associated with each the other users in the call and decoded by the communication client 222. Therefore in the example embodiment shown in FIGS. 3 and 3a, the first communication client 222a will resolve the received audio streams to each of the users B, C, D and E respectively. By default, at the start of the call the audio streams are played out to the first user (via loudspeaker(s) 214) with the output volume levels for each of the streams set an equal level. The initial output volume of the audio streams will usually be set relatively low so that the mixed audio streams that are played out will simulate a background “chatter” effect. The initial output volume of the audio streams may be stored in memory as a preference setting of the communication client 222, referred to hereinafter as the “background chatter volume” setting.

The simulated background chatter effect increases the collaborative nature of the group of users involved in the meeting room interface in that they are connected for an ongoing duration of time and able to communicate with one another throughout the duration of their connection.

The first user (e.g. user A) can listen to the played out streams and if something they hear from one of the other users is of particular interest, the first user can use the control slider 314 associated with that other user to independently control the volume of the audio stream associated with that other user. For example if when listening to the background chatter the first user (user A) hears user B mention something of interest, user A can selectively use the volume control slider 314b associated with user B to increase the audio play out volume of the stream associated with user B. In response the communication client 222a adjusts the output of the stream associated with user B to be increased relative to the other user's whose output streams remain at their starting level.

In an alternative embodiment, when user A increases the volume level of the audio stream of one of the other users (e.g. user B) the volume of other audio streams associated with each of the other users may be automatically decreased by a related amount. In this case the volume control sliders 314 associated with the other users and displayed in the user interface 306 (and mixer control window 320) will automatically be adjusted by the communication client 222a as appropriate. The related amount may be either proportional or disproportional to the increase in volume applied to the play out of the stream associated with user B.

Alternatively or in addition, user A can independently decrease the play out volume associated with one or more of the other users (e.g. C, D, E) by using the slider control(s) 314 associated with those other users. For example if the user A finds that the play out volume of the streams associated with any of those other user(s) (C, D, E) is distracting him from hearing what user B is saying, he can use the volume slider controls 314 to mix the audio streams as appropriate. The other users will have the same volume control tools at their disposal so that they too can increase and/or decrease the volume of the received audio streams from the other users from the perspective of their own communication client 222.

Thus the volume control sliders 314 may adjusted by the first user (user A) so as to allow the audio output streams associated with users B, C, D and E to be mixed accordingly. The volume control sliders 314 each represent a scale of the volume for an output audio stream associated with one of the other user. The scale comprises a virtual control knob or actuatable element that may be moved up and down the length of the scale of the slider by using a mouse, keyboard or finger gesture input (e.g. tap or drag) on a touchscreen. The scale is typically linear ranging from zero (minimum output) through increasing discrete levels up to a maximum output volume. Each slider may have various levels of granularity so that the slider may have anywhere between two and an order of hundreds of different discrete volume levels. The granularity for each slider may be altered according to the first user in preference settings of his communication client 222.

A corresponding volume level may be temporarily displayed proximate to each volume control slider 314. Alternatively the displayed volume level may be shown permanently. The displayed volume level may be updated dynamically as a user changes the volume output of the audio stream associated with that slider. The displayed volume level may be shown as a number ranging from “0” (minimum output) up to “100” (maximum volume output). The displayed volume level may be shown in other ways including but not limited to a decibel (dB) value or a phon value.

How loud the output volume is actually perceived by the first user will depend on a number of factors including: the user's auditory sensory system (hearing), the type of loudspeaker(s) 214 being used with the terminal 102, any volume settings made by the first user at the system level (discussed below), and any number of external factors.

Although the present disclosure makes reference to slider volume controls 314, these volume controls 314 may be represented in an alternative form to sliders e.g. some alternative examples may include but are not limited to: virtual rotary volume control, discrete buttons (e.g. high volume, medium volume, low volume) or by entering a numerical volume value via a keyboard or soft keyboard input.

In some embodiments rather than explicitly initiating or accepting a specific group audio call, each of the communication clients 222 of a group of users (e.g. users A, B, C, D and E) may be configured to “check in” the user into meeting room interface 306 as part of an ongoing communication session between a particular group of users (for example a team of co-workers). The meeting room interface stays open and is left running in the background of the user's user terminal 102. For example the meeting room interface 306 may be left running throughout the course of a working day. In this manner the audible background chatter played out at the first user's terminal 102 will continue during the course of the day or while the first user remains part of the meeting room interface 306.

In some embodiments a user does not have to remain in the group call and may leave (“check out of”) the meeting room interface or close down the communication client application 222 altogether. Further, in some embodiments a user may initiate or join one or more additional communication sessions with one or more other users, at the same time as taking part in the original communication session. The one or more other users in the additional communication session(s) may or may not include any one or more of the users involved in the original communication session (e.g. users A, B, C, D and E) in the described embodiments.

The following provides an example scenario of how control of the background chatter effect is realised. Staying with the connection established between the five users A, B, C, D and E and from the perspective of the first user (user A), user A sees the users B, C, D and E represented in the meeting room interface area 306. To start all of the users are in the background chatter mode with the streams associated with each user at the same volume level. User B may be talking a lot about things that are not relevant to what the user A wants to hear. On the other hand, user C may be quite reserved but is talking about things that are extremely relevant or important to user A. User A can use the volume control sliders 314 associated with the users B and/or C (and any of the other users, D and E) to adjust play out of the audio streams accordingly. For example it's likely that user A will increase the volume of the play out of the stream for user C and/or decrease the play out of the stream for user B.

In some embodiments, when the first user (user A) uses the slider volume controls 314 to effect a change in volume of the audio stream associated with one the other users in the meeting room interface, the communication client 222 of said other user will perform the same change in volume but for the play out stream associated with user A. For example if user A increases the play out volume of the stream associated with user C, a corresponding increase in volume is automatically made to the play out volume of the stream associated with user A but at user C's communication client 222. This may be achieved by the communication client 222a of the transmitting terminal 102a (e.g. the first user's terminal 102a) by including side information with the transmitted encoded audio data. The side information is a volume instruction relevant to user terminal C and which defines a volume at which the decoded audio should be played out at, at the user terminal C. Each user's volume is represented by a single floating point variable and the value of the floating point can be updated when the volume instruction is received. The encoded audio data and side information may be received by the server 104a. The server 104a may then process the encoded audio data and forward the data with the side information (volume instruction) on to the relevant user terminal i.e. user terminal 102c. Alternatively the encoded audio data and instruction may be routed directly between the user terminals 102 without the need for server 104a.

If the first user changes the volume of the audio stream associated with multiple users, then the first user terminal transmits the encoded audio data to server 104a along with respective volume instructions (in the form of respective sets of side information) relevant to each of the other user terminals 102. The server 104a ensures that the correct volume instruction is forwarded to the correct user terminal 102. Again, in an alternative embodiment the respective volume instructions may be routed directly between the communication clients without the need for server 104a.

When communication client 222c receives the encoded audio data and the volume instruction, it decodes the audio data and volume instruction and plays out the audio stream via speaker(s) 214 at a volume corresponding to the volume instruction. This has the effect of simulating when a team member of an open plan environment moves closer to speak with another member of the team i.e. the speech volume that they each hear from one another is increased as they are now physically closer to one another. This has the effect of virtually pushing the remaining streams that form the “background chatter” further into the background as more prominence is given to the streams which have been increased in volume.

In the opposite scenario if user C selects to increase the play out volume associated with the stream of one of the other users (e.g. user A) this will cause the play out volume of the stream associated with user C to be similarly increased at user A's terminal 102a based on a volume instruction received along with the encoded audio data originating from user terminal 102c. The encoded audio data and volume instruction may be received from server 104a or communicated between the user terminals in a peer-to-peer manner known in the art.

FIG. 3b shows a system volume control mixer interface 322 of a particular terminal 102 that may be used to ultimately dictate how loudly received audio data streams will be played out at that terminal 102. For example the system volume control mixer interface 322 at user terminal 102a may be used by user A to change how loud the output streams actually are when played out. That is, even though one or more remote users (e.g. user C in the above example) may be able to influence the volume of the play out of an audio stream associated with that remote user, the first user may still be in full control of the system volume (which is not be controllable by any of the other remote users). For example, the system volume control 322 may be implemented at the Operating System level and be able to handle volume levels associated with each of a number of different applications (including communication client application 222). Thus the system volume control may include a volume control slider 324 to adjust the overall volume level associated with the output audio streams relating to the communication client 222. For example the output volume of the communication client 222 may be set relatively loud or relatively quiet compared to other applications which may their own volume control sliders 326 in the system volume control mixer interface 322. It is noted that the audio output generated from other applications does not usually form part of the audio data transmitted and received by the communication clients 222. For example this allows a user to be involved in the meeting room interface and still use other applications that include audio.

The system volume control mixer interface 322 may further include an overall master volume level control 328 for controlling the volume of all of the output audio streams at the terminal 102. For instance if user A at terminal 102a has quite sensitive hearing, he may use the overall master control volume to lower the system volume. Conversely, if user A is struggling to hear the output through speaker(s) 214, he may increase the master control volume. Thus, while the relative volume differences between the audio output streams associated with the different users in the meeting room interface may be maintained, the overall volume as output at the loudspeaker(s) 214 can be fully controlled by the first user.

In some embodiments a first user (e.g. user A) can use his communication client 222 to select a control to revert the output volume level of all of the audio output streams associated with the other users back to the level defined by a background chatter volume setting. Such control may be effected by a “background chatter mode” control button 330 displayed for example in the user interface 306. When the user selects “background chatter mode” control button 330, the volume control sliders associated with each of the others users (e.g. B, C, D and E in FIG. 3) are reset to the background chatter volume level. The background chatter volume level may be a predefined level set by the first user and saved as a user preference setting of his communication client 222. Alternatively the background chatter volume level may be defined to be in relation to the current volume of the overall master volume level of the user terminal. Purely as an example, the background chatter volume level may be set as 20% of the current overall master volume level. In another embodiment a volume control slider 332 for the background chatter mode volume level may be displayed in the meeting room interface 306 and/or in the system volume control mixer interface 322, so that the background chatter volume level can be adjusted either during and/or in advance of the background chatter mode being in effect.

In some embodiments a first user (e.g. user A) may not want to hear one or more users (e.g. user C) with increased relative volume at his user terminal 102a. In this case, user A may “undo” the increase in volume by manually using his volume control sliders 314 to decrease the volume of the play out of the audio stream associated with user C. Alternatively there may be an “undo” last change control button (not shown) that the user can select to revert to the volume settings that were in effect immediately before the last change.

In order to prevent another user from continuously effecting a change in the volume settings for the play out stream associated with that other user, the first user may be able to select a preference setting of their communication client 222a to temporarily override the other user's attempts to change the volume settings at the first user's terminal. For example, user A may be able to set an override function in relation to user C. Therefore user C may still use their volume control sliders 314 at to effect a change in the play out volume of the stream associated with user A at terminal 102c, but the change has no effect at user A's user terminal 102a. The override setting may be temporary in that it only prevents a remote user from changing the output volume levels as output at user A's terminal 102a for a limited period of time. After expiry of the set time limit the remote user (e.g. user C) may be able to effect a volume change at user A's terminal 102a from the volume control slider 314 that is associated with user A.

In other embodiments, the first user (user A) can use the volume control sliders 314 to effect a change in volume of the play out stream associated with more than one of the other users (e.g. B, C, D, E) in the meeting room interface. Assuming that the other users do not have the override function set, a corresponding change will be made to the play out volume of the stream associated with user A at each of the other users' terminals 102.

In another embodiment the first user (user A) may use the mute control buttons 312 to fully mute the play out of one or more of the other users in the meeting room interface. Although muting has the effect of breaking down the collaborative nature of a simulated open plan environment, it is still a useful feature available to the user of the meeting room interface for reasons now set out. For example if user A does not wish to hear what user B is saying at all, he can select the mute control 312b associated with user B to completely silence the play out of the audio stream associated with user B. This also has the effect of effectively blocking the transmission of audio data from user A's communication client 222a to user B's communication client 222b i.e. user A is muted from the perspective of user B. A signal may be transmitted from user terminal 102a to user terminal 102b which indicates that user A has muted their audio from user B. In embodiments the mute indication signal may be transmitted to and processed by server 104a and forwarded on to the communication client 222b of user B. Such an indication may be processed by the communication client 222b which causes a graphic “muted” icon to be displayed beside the visual representation of the user A in user B's interface.

When user A has muted the audio stream associated with user B, the mute control button 312b associated with user B is changed by the communication client to “unmute” in the user interface display. When user A selects the “unmute” button 312b, this has the effect of unmuting user B. That is, the audio play out of the stream associated user B will resume and the audio. This will also unblock the transmission of audio data from user A's communication client 222a to user B's communication client 222b. The “unmute” control button 312b will be changed by the communication client 222a again back to the original “mute” control button 312b. Alternatively, rather than selecting the “unmute” control, user A can unmute the stream associated with user B by moving the slider control 314b. By moving the slider, either to a new position on the scale or to where it already was will unmute the audio stream associated with user B.

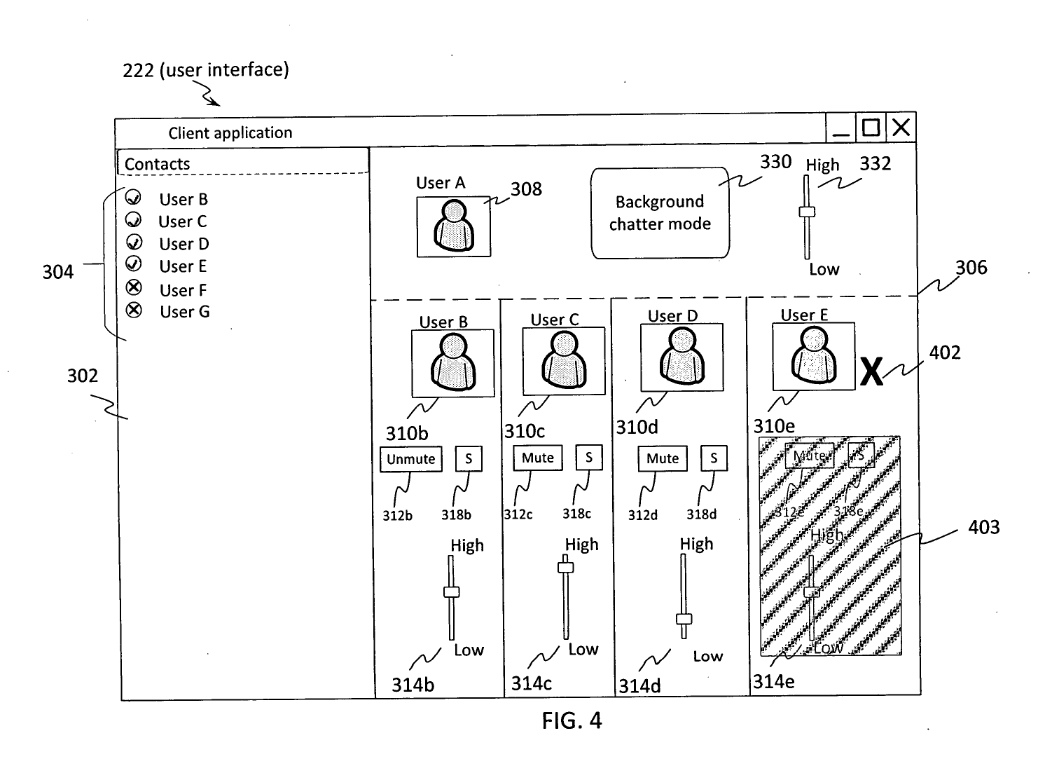

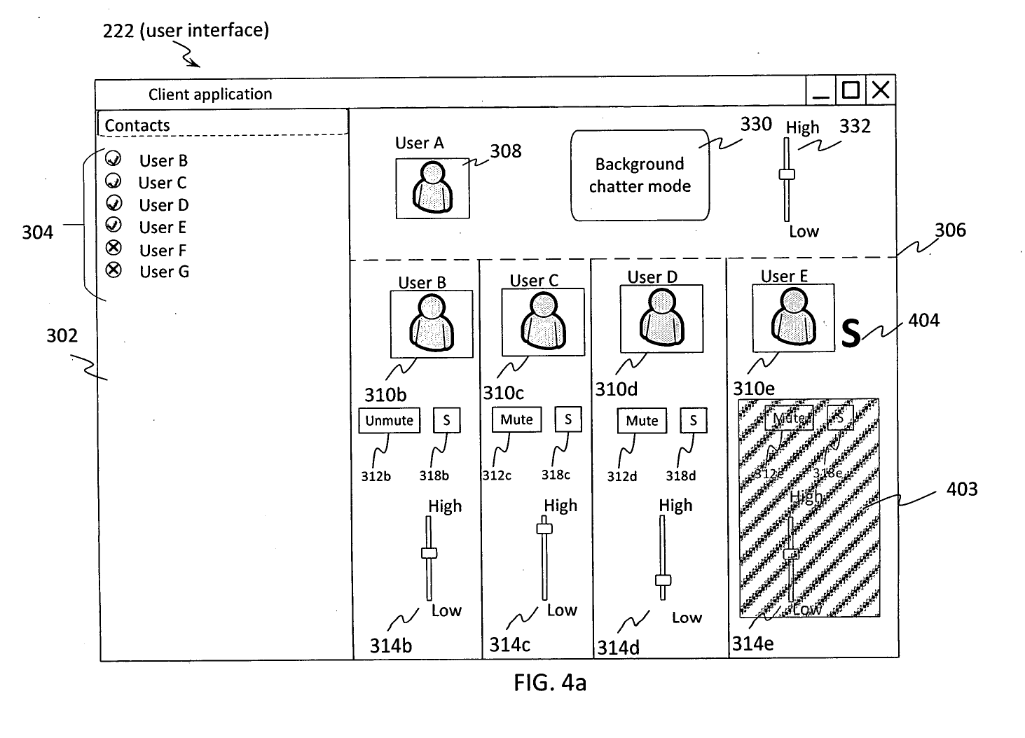

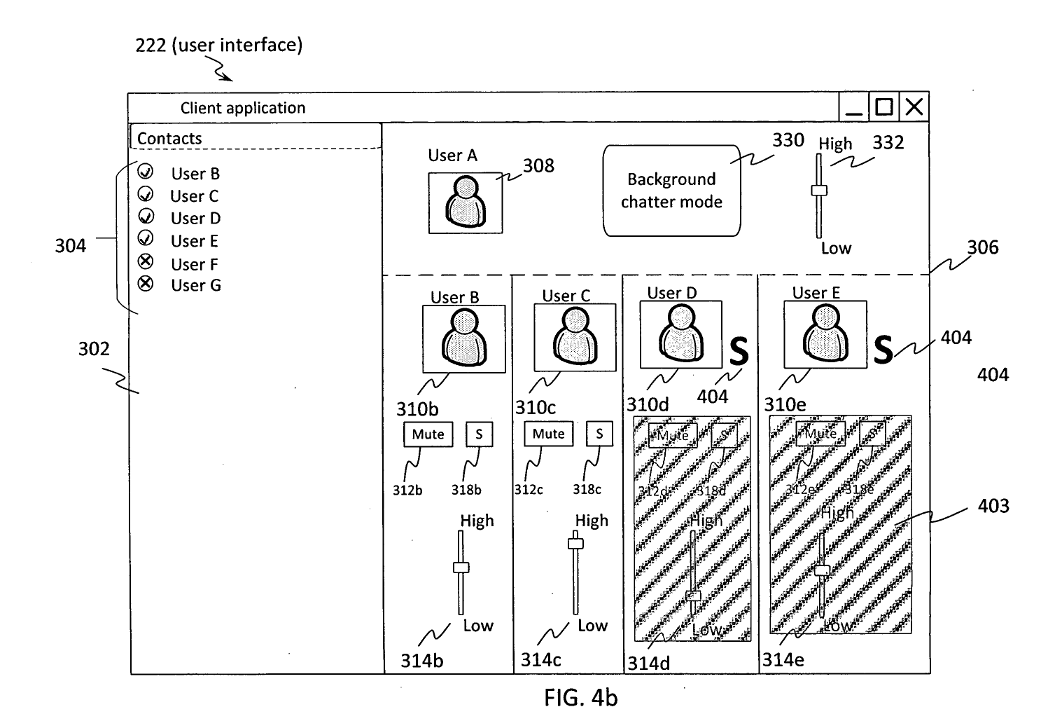

Referring to FIG. 4, another example of the meeting room interface 306 from the perspective of the first user, user A, is shown. In this embodiment user A has muted the audio stream associated with user B by selecting the mute control button 312b. As a result mute control button 312b has been changed and is shown displayed in the interface as an “unmute” control button 312b. When the “unmute” control button 312b is selected the audio stream play out associated with user B will be unmuted (and the transmission of audio data from communication client 222a to communication 222b will be unblocked) when selected again.

The volume control slider 314c associated with user C has been set relatively high so that the play out of the audio stream associated with user C will be louder compared to the play out of the other audio streams.

The volume control slider 314d associated with user D has been set relatively low so that the play out of the audio stream associated with user D will be quieter compared to the play out of the other audio streams. Note that the output stream has not been muted and user A still hears the output stream associated with D. Likewise, as described above, the volume of the audio stream associated with user A output at terminal 102d will be automatically set to the same volume level as that of the output stream associated with user D output at the first user terminal 120a.

A “muted” icon 402 is shown beside user E which indicates that user E has decided to mute user A. The muted icon 402 may take any suitable graphical form, may be animated, and may also include an audio notification. User E may be considered to be a “muting user”. This has the effect that communication client 222a will no longer receive the audio stream transmitted from user E's terminal 102e. The volume control 314e associated with the audio stream of user cannot be used while the user E has muted user A. The communication client 222a updates the user interface to “grey out” and make unavailable the volume control slider 314e, the mute control button 312e and the solo control 318e. The greyed out area is shown represented by area 403 in FIG. 4 (and FIGS. 4a and 4b described later). Note that the slider position does not change and when user E unmutes user A, the audio stream play out associated with user E will resume at the same level prior being muted. Once unmuted, the communication client 222a makes the volume control slider 314e and mute control button 312e available once again.

In embodiments, when user A has muted another user in the call, the communication client 222a may determine that audio is still being transmitted to communication clients 222 of other non-muted users. The determination may be based on the communication client 222a detecting an input from the microphone 212. In this situation rather than displaying a muted control icon 402 in the user interface of the muted user, a side conversation icon 404 is displayed instead. The side conversation icon 404 may take any suitable graphical form, may be animated, and may also include an audio notification. This side conversation icon 404 is shown in FIG. 4a which depicts the meeting room interface 306, again from the perspective of user A. Here user E has muted user A such that the audio stream associated with user E is not being received by communication client 222a. However the communication client 222e at terminal 102e detects that the audio is still being transmitted for one or more other users in the call. Communicating client 222e will transmit a signal to communication client 222a which informs that user E is in a side conversation with one or more of the other communication clients. Based on the information in the received signal communication client 222a uses generates the side conversation icon 404 beside user E's graphical representation at area 310e.

If multiple users in the call have muted user A, this may be because those users want to hold a side conversation between themselves i.e. without the presence of user A (and possibly other users too). This is shown for example in FIG. 4b, where both users D and E have muted user A. Users D and E may be referred to as “muting users”. If the communication clients 222 of any these “muting users” determine that audio data is being transmitted to any other users (including between the other “muting users” i.e. between users D and E) then they each send transmit a signal for communication client 222a (and the communication client(s) for any other muted users) which informs that the muting users are in a side conversation. The information may not specify that a “muting user” is taking part in a particular side conversation, only that they are taking part in a side conversation. Based on the information in the received signals communication client 222a generates the side conversation icon 404 beside users D and E's graphical representation at areas 310d and 310d in the meeting room interface. Therefore, user A will be able to determine that muting users are still active in some capacity in the call, despite having muted communication transmissions to and from user A in the call. Note that user A is still part of the call and is still able to communicate with any other non-muting users (or users that have not been muted by user A) that are still on the call, e.g. Users B and C in the example shown in FIG. 4b.

The ability to reduce or mute the output volume levels of one or more audio streams associated with different users may be beneficial from the perspective of a first user e.g. user A. For example, users A, B, C, D and E are all connected in the communication session and shown in meeting room interface 306. The users are all communicating and the outputs are all set relatively low so that the mixed audio streams that are played out simulate the background “chatter” effect. At some point users D and E may start talking about something that is irrelevant or not interesting to user A. For example users D and E may have started a “side conversation” while still in the original communication session. There may be other reasons that the first user, user A, may not want to hear the audio streams associated with these users that would be understood by the skilled person. Therefore user A may select to reduce the volume of the output streams associated with either or both of users D and E by effecting the volume control sliders 314d and 314e associated with users C and D. Rather than merely reducing the volume of the output streams associated with users C and D, user A may select to fully mute the output streams for either or both of users C and D by effecting the mute control buttons 312d and 312e associated with users C and D.

Alternatively, or in addition, user A may decide to increase the output volume of the audio streams associated with the user(s) he wants to hear more from. For example user A can affect the volume control sliders 314b and/or 314c to increase the volume of the output audio streams associated with users B and C.

The ability to mute one or more audio output streams associated with different users may also be beneficial for reasons of privacy. For example, user A may have may have something he wants to communicate only to one or more of the users in the meeting room interface 306, but not all of them. For instance, user A may want to say something so that only user B receives the communication. Alternatively, user A may want to say something so that particular users are excluded from receiving the communication. By using the mute control button 312 a first user (user A) can ensure that only certain other user(s) are allowed to receive their communication transmissions.

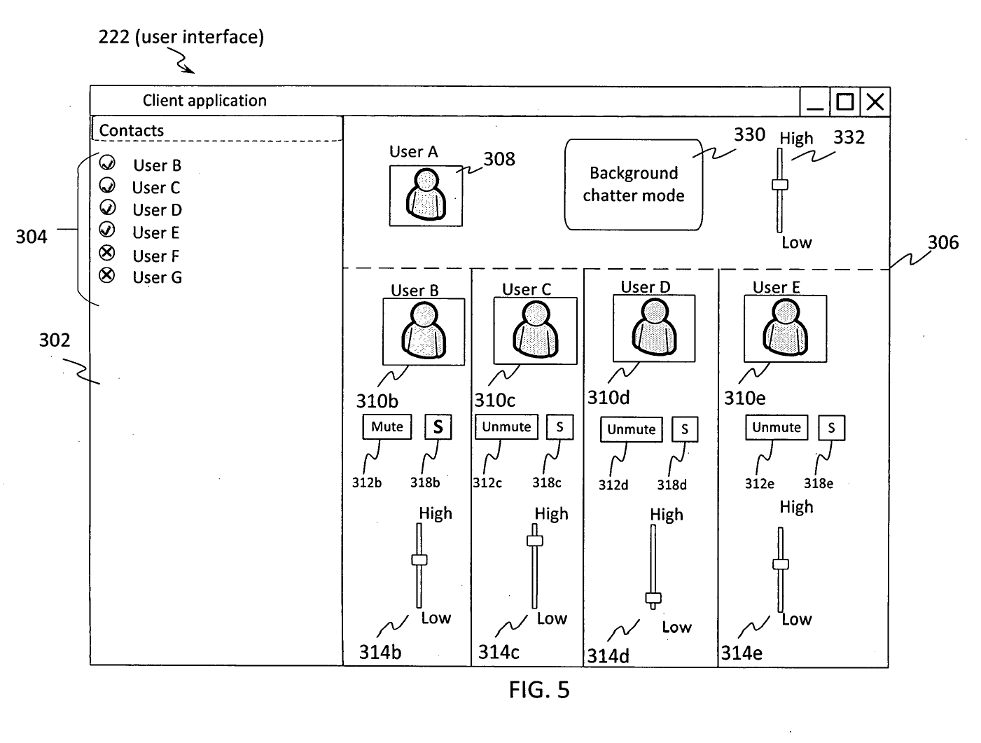

Referring to FIG. 5, in a situation where a first user (e.g. user A) wants only one other user (e.g. user B) to receive their communications, the first user can select a “solo” control button 318 in the meeting room interface 306 that is associated with the one other user (or in the separate mixer control window 320). For example, user A may select “solo” control button 318b associated with user B, which causes the audio communication streams transmitted to and received from all of the other users in the meeting room interface (i.e. users C, D and E) to be muted in a manner as described above.

The communication client 222a may control the user interface to update the solo control button 318b by highlighting it in some way to show that it has been selected. The highlighting may comprise any one or more of bold text, visual effects such as lighting changes, colour changes and/or animations. By selecting the solo control button 318b, the first user does not have to manually select each of the mute control buttons 312 associated with each of the users he wants to mute. Because the other users C, D and E have been muted, the mute control buttons associated with those users 312 are changed by the communication client 222a to show “unmute” in the first user's interface (as described above). The first user can then select to unmute any of users of C, D and E even while the solo control for user B is still on. The first user may select to turn off the solo effect at any time by selecting the solo control button 318 again. This will have the effect of un-highlighting the solo control button 318 and unmuting all of the other muted users i.e. users C, D and E in FIG. 5.

There may be a solo control button 318 associated with each of the users in the meeting room interface. The first user may select any number of the solo control buttons 318. For any other users in the meeting room interface 306 that have not had a solo control button 318 selected by the first user, the audio communication streams transmitted to and received from those other users is muted. Thus if the first user selects the solo control buttons 318 for all of the users in the meeting room interface, this will have the same effect as having all of the users unmuted.

It should be noted that if any of the other users have muted the first user (user A), the first user cannot use the solo control button 318 associated with the user that has muted them. Instead the communication client 222a updates the user interface to “grey out” and make unavailable the solo control button along with the volume control slider 314 and mute control button 312 associated with the muting user (as described above in relation to FIGS. 4, 4a and 4b in which user E is a muting user).

In some embodiments of the present disclosure, the use of any of the audio controls 312, 314, 318, 330 and 332 and other ways in which any of the users use features of and/or interact with the meeting room interface 306 may be monitored. Control data on how each user is using the features of the meeting room interface may be generated automatically by each of the communication clients 222 in real time e.g. immediately upon a user using the audio controls or generated upon expiry of a time interval. The generated control data is then transmitted to a remote database 105 for storage. The transmission of the control data may also be performed in real time or may be performed upon expiry of defined time intervals.

Alternatively or in addition to the communication clients 222 generating and transmitting control data, the control data may be generated by central server 104a which may infer how each user is using the audio controls based on the changes to the encoded audio data and instructions received from the communication clients 222 at the server 104a.

An administrator user Z of system 100 has a user terminal 102z which has privileged access to the stored control data at databased 105. The privileged access may be by way of user Z using a version of the communication client application 222z with administrator privileges. Database 105 may be directly accessible by terminal 102z or may be accessible via a server, for example the server 104a. The control data allow the administrator and other privileged users associated with the system 100 to see how the users of the meeting room interface 306 are using the features of the meeting room interface.

For example the control data may provide insight into which users are having their volume turned down and/or muted more than other users. Conversely the data can show which users are having their volume turned up more than others. The control data may reveal patterns as to which users are performing side conversations (i.e. where muting users continue to transmit audio data to one or more other users). The data may also show for how long and how often users are “checking in” to the meeting room interface. It may be apparent that certain users are not really engaging with the meeting room interface as they may be constantly “checking out” of the meeting room interface 306 or selecting to mute many of the other users in the communication session.

In some embodiments, the first user terminal 102a transmits an encoded audio data stream for reception by the other user terminals 102.

In some embodiments, based on controlling, the first communication client generates and transmits to a second of the user terminals a volume instruction for causing the second user terminal to play out the encoded audio data stream transmitted from the first user terminal with an output volume level denoted by the volume instruction.

In some embodiments, the method further comprises, the first communication client generating a respective volume instruction for causing a second user terminal to play out the encoded audio data stream transmitted from the first user terminal with an output volume level that is the same as the controlled output volume level at the first user terminal.

In some embodiments, the method further comprises the selected audio data stream being the one associated with the second user terminal and the independently controlling step comprises changing the output volume level of the selected audio data stream in response to a local volume change input from the first user; and wherein the volume instruction is transmitted to the second user terminal by the first user terminal also in response to the local volume change input to cause at the second user terminal

In some embodiments, the method further comprises initially setting the output volume level of each of the received audio data streams to a same audible level.

In some embodiments, the same audible level is a proportion of an overall master volume output level of the first user terminal.

In some embodiments, the method further comprises controlling the output volume level of each of the received audio data streams to revert back to the initially set same audible level.

In some embodiments, the method further comprises displaying a user interface of the first communication client, the user interface comprising a plurality of user-actuatable audio volume controls 314 respectively associated with each of the received audio data streams.

In some embodiments, the step of independently controlling, within an audible range, an output volume level of at least a selected one of the received audio data streams output through the one or more audio output devices 214 further comprises actuating one or more of the audio volume controls 314.

In some embodiments, the audio volume controls 314 may be any of: a virtual volume control slider, a virtual rotary volume control knob, and discrete volume change buttons.

In some embodiments, the method further comprises automatically changing, within an audible range, the output volume level of one or more of the received audio data streams; wherein said automatically changing the output volume level is based on receiving, at the first user terminal 102a, a respective volume instruction which is received with said one or more of the received audio data streams.

In some embodiments, the method further comprises setting a control at the first communication client 222a to override the step of automatically changing the output volume level of one or more of the received audio data streams.

In some embodiments, the user-actuatable audio volume controls comprise mute control buttons 312 for temporarily muting one or more of the received audio data streams output through the one or more audio output devices 214.

In some embodiments, the method further comprises receiving a signal from one or more of the other user terminals 102 when the transmitted encoded audio stream has been muted by a respective user at said one or more of the other user terminals but said one or more of the other user terminals are still receiving an audio input as part of the group communication session; wherein the signal indicates to the first user terminal that the respective user at said one or more of the other user terminals is in a side conversation.

In some embodiments, the method further comprises displaying a system volume control interface 322 suitable for controlling an overall master volume output level of all audio signals output through the one or more audio output devices 214.

In some embodiments, the method further comprises the first communication client 222a generating data relating to the step of independently controlling, within an audible range, an output volume level of at least a selected one of the received audio data streams; and transmitting said data to a remote database 105 over the network 108 so that the data can be monitored.

In some embodiments, the received audio data streams and the encoded audio data stream transmitted by the first terminal 102a are routed via a remote server.

In some embodiments, the remote server 104a is a multipoint control unit, optionally an audio-visual multipoint control unit.

In embodiments, the first user terminal 102a is configured in accordance with any of the above described methods.

In embodiments, the communication client 222 application is configured to perform any of the above described methods.

Generally, any of the functions described herein can be implemented using software, firmware, hardware (e.g., fixed logic circuitry), or a combination of these implementations. The terms “module,” “functionality,” “component” and “logic” as used herein generally represent software, firmware, hardware, or a combination thereof. In the case of a software implementation, the module, functionality, or logic represents program code that performs specified tasks when executed on a processor (e.g. CPU or CPUs). The program code can be stored in one or more computer readable memory devices. The features of the techniques described below are platform-independent, meaning that the techniques may be implemented on a variety of commercial computing platforms having a variety of processors.

For example, the user terminals 102 may also include an entity (e.g. software, such as the client 222) that causes hardware of the user terminals to perform operations, e.g., processors functional blocks, and so on. For example, the user terminals may include a computer-readable medium that may be configured to maintain instructions that cause the user terminals, and more particularly the operating system and associated hardware of the user terminals to perform operations. Thus, the instructions function to configure the operating system and associated hardware to perform the operations and in this way result in transformation of the operating system and associated hardware to perform functions. The instructions may be provided by the computer-readable medium to the user terminals through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may us magnetic, optical, and other techniques to store instructions and other data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of operating a first user terminal of a first user, comprising:
running a first communication client application on the first user terminal so as to enable the first user terminal to participate in a group communication session over a network with respective communication clients running on other user terminals;
receiving, by the first user terminal, a plurality of audio data streams, each carrying audio data generated at a respective one of the other user terminals;
the first communication client associating each of the received audio data streams with a respective user of one said other user terminals;
the first communication client outputting the received audio data streams through one or more audio output devices associated with the first user terminal; and
independently controlling, within an audible range, an output volume level of at least a selected one of the received audio data streams output through the one or more audio output devices.

2. The method of claim 1 further comprising the first user terminal transmitting an encoded audio data stream for reception by the other user terminals.

3. The method of claim 2 further comprising the first communication client generating and transmitting to a second of the user terminals a volume instruction for causing the second user terminal to play out the encoded audio data stream transmitted from the first user terminal with an output volume level denoted by the volume instruction.

4. The method of claim 3 wherein the selected audio data stream is the one associated with the second user terminal and the independently controlling step comprises changing the output volume level of the selected audio data stream in response to a local volume change input from the first user; and
wherein the volume instruction is transmitted to the second user terminal by the first user terminal also in response to the local volume change input to cause at the second user terminal a corresponding change in the output volume level of the encoded audio data stream transmitted by the first user terminal.

5. The method of claim 1 further comprising initially setting the output volume level of each of the received audio data streams to a same audible level.

6. The method of claim 5 wherein said same audible level is a proportion of an overall master volume output level of the first user terminal.

7. The method of claim 5 further comprising controlling the output volume level of each of the received audio data streams to revert back to the initially set same audible level.

8. The method of claim 1 further comprising displaying a user interface of the first communication client, the user interface comprising a plurality of user-actuatable audio volume controls respectively associated with each of the received audio data streams.

9. The method of claim 8, wherein the step of independently controlling, within an audible range, an output volume level of at least a selected one of the received audio data streams output through the one or more audio output devices further comprises actuating one or more of the audio volume controls.

10. The method of claim 1, wherein the step of independently controlling is performed by the first communication client application according to respective volume instructions received at the first user terminal from the other user terminals.

11. The method of claim 1 further comprising automatically changing, within an audible range, the output volume level of one or more of the received audio data streams; wherein said automatically changing the output volume level is based on receiving, at the first user terminal, one of the respective volume instructions which is received with said one or more of the received audio data streams.

12. The method of claim 11 further comprising setting a control at the first communication client to override the step of automatically changing the output volume level of one or more of the received audio data streams.

13. The method of claim 8 wherein the user-actuatable audio volume controls comprise mute control buttons for temporarily muting one or more of the received audio data streams output through the one or more audio output devices.

14. The method of claim 2 further comprising receiving a signal from one or more of the other user terminals when the transmitted encoded audio stream has been muted by a respective user at said one or more of the other user terminals but said one or more of the other user terminals are still receiving an audio input as part of the group communication session; wherein the signal indicates to the first user terminal that the respective user at said one or more of the other user terminals is in a side conversation.

15. The method of claim 1 further comprising displaying a system volume control interface suitable for controlling an overall master volume output level of all audio signals output through the one or more audio output devices.

16. The method of claim 1 further comprising the first communication client generating data relating to the step of independently controlling, within an audible range, an output volume level of at least a selected one of the received audio data streams; and transmitting said data to a remote database over the network so that the data can be monitored.

17. The method of claim 2 wherein the received audio data streams and the encoded audio data stream transmitted by the first terminal are routed via a remote server.

18. The method of claim 17 wherein the remote server is a multipoint control unit, optionally an audio-visual multipoint control unit.

19. A user terminal, comprising:
a processor configured to run a first communication client application on the user terminal so as to enable the user terminal to participate in a group communication session over a network with respective communication clients running on other user terminals;
a network interface configured for receiving a plurality of audio data streams, each carrying audio data generated at a respective one of the other user terminals;
wherein the first communication client is configured for:
associating each of the received audio data streams with a respective user of one said other user terminals;
outputting the received audio data streams through one or more audio output devices associated with the user terminal; and
independently controlling, within an audible range, an output volume level of at least a selected one of the received audio data streams output through the one or more audio output devices.

20. A communication client application embodied on a computer readable storage medium and comprising code configured so as when run on a first user terminal to enable the first user terminal to participate in a group communication session over a network with respective communication clients running on other user terminals by implementing at least the following steps:
receiving, by the first user terminal, a plurality of audio data streams, each carrying audio data generated at a respective one of the other user terminals;
the first communication client associating each of the received audio data streams with a respective user of one said other user terminals;
the first communication client outputting the received audio data streams through one or more audio output devices associated with the first user terminal; and
independently controlling, within an audible range, an output volume level of at least a selected one of the received audio data streams output through the one or more audio output devices.
